(19) United States
(12) Patent Application Publication
(10) Pub. No.: US 2021/0197728 A1
(43) Pub. Date: Jul. 1, 2021

(54) Electronic Device Carrier and Shade

(71) Applicant: Ricardo Brown, Dallas, GA (US)

(72) Inventor: Ricardo Brown, Dallas, GA (US)

(21) Appl. No.: 16/731,180

(22) Filed: Dec. 31, 2019

(51) Int. Cl. B60R 7/06; H04M 1/04; B60R 7/08; B60K 37/02; B60R 11/02

(52) U.S. Cl. CPC B60R 7/06; H04M 1/04; B60R 2011/0008; B60K 37/02; B60R 11/0241; B60R 7/08

(57) ABSTRACT

An electronic device carrier and shade for holding and shading a personal electronic device includes a housing. The housing has a rear wall, a bottom wall, a top wall, a first lateral wall and a second lateral wall. The housing has a front side which is open and forms an access into an interior of the housing. The interior removably receives a personal electronic device. The top wall is attached to and extends forwardly from the rear wall. The bottom wall has a distal edge with respect to the rear wall. The distal edge lies in a vertical plane oriented perpendicular to a top side of the bottom wall. The top wall extends through the vertical plane to shade the interior of the housing. A coupler is attached to a back side of the rear wall. The coupler removably couples the housing to louvers of a car vent.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to personal electronic device carriers and shade devices and more particularly pertains to a new personal electronic device carrier and shade device for holding and shading a personal electronic device. The disclosure allows for the personal electronic device to be held within the housing and shaded while in the housing. The disclosure does not attach to the personal electronic device.

### (2) Description of Related Art Including Information Disclosed Under 37 CFR 1.97 and 1.98

The prior art relates to personal electronic device carriers and shade devices. Prior disclosures describe devices which attach to the personal electronic device for both hand held use and hands free use.

### BRIEF SUMMARY OF THE INVENTION

An embodiment of the disclosure meets the needs presented above by generally comprising a housing. The housing has a rear wall, a bottom wall, a top wall, a first lateral wall and a second lateral wall. The housing has a front side which is open and forms an access into an interior of the housing. The interior is configured to removably receive a personal electronic device. The top wall is attached to and extends forwardly from the rear wall. The bottom wall has a distal edge with respect to the rear wall. The distal edge lies in a vertical plane which is oriented perpendicular to a top side of the bottom wall. The top wall extends through the vertical plane to shade the interior of the housing. A coupler is attached to a back side of the rear wall. The coupler is configured to removably couple the housing to louvers of a car vent.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of an electronic device carrier and shade according to an embodiment of the disclosure.

FIG. 2 is a rear isometric view of an embodiment of the disclosure.

FIG. 3 is a side view of an embodiment of the disclosure.

FIG. 4 is a rear view of an embodiment of the disclosure.

FIG. 5 is an in-use view of an embodiment of the disclosure.

### DETAILED DESCRIPTION OF THE INVENTION

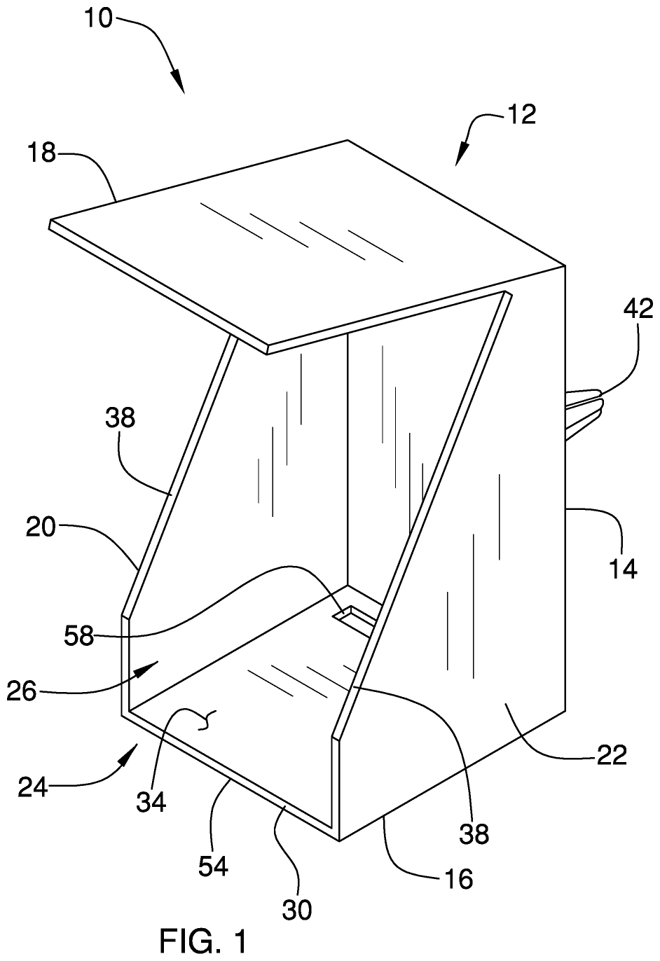

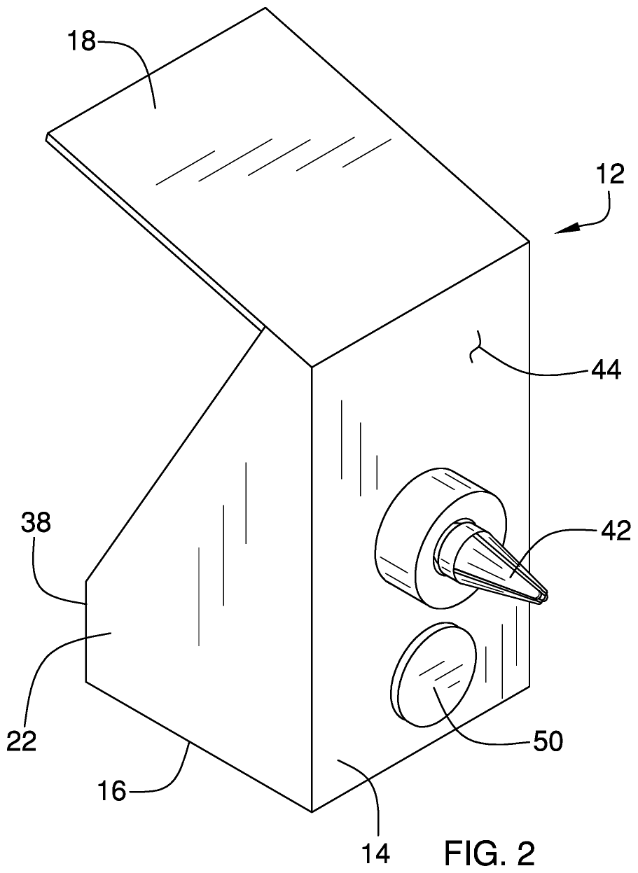

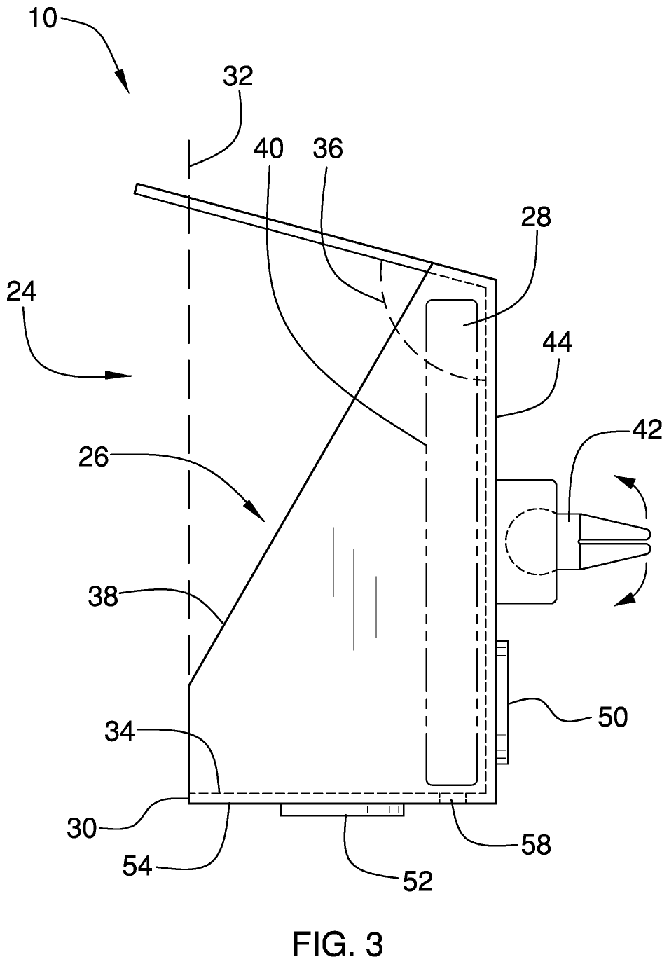

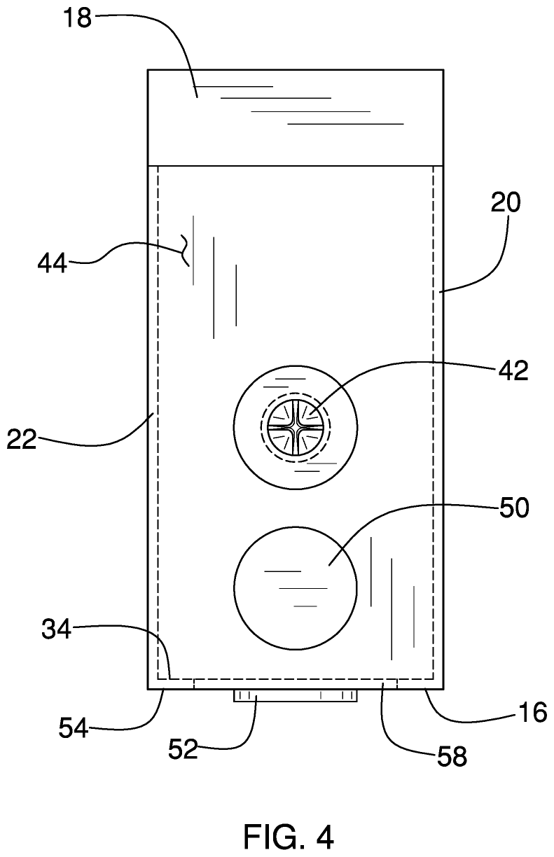

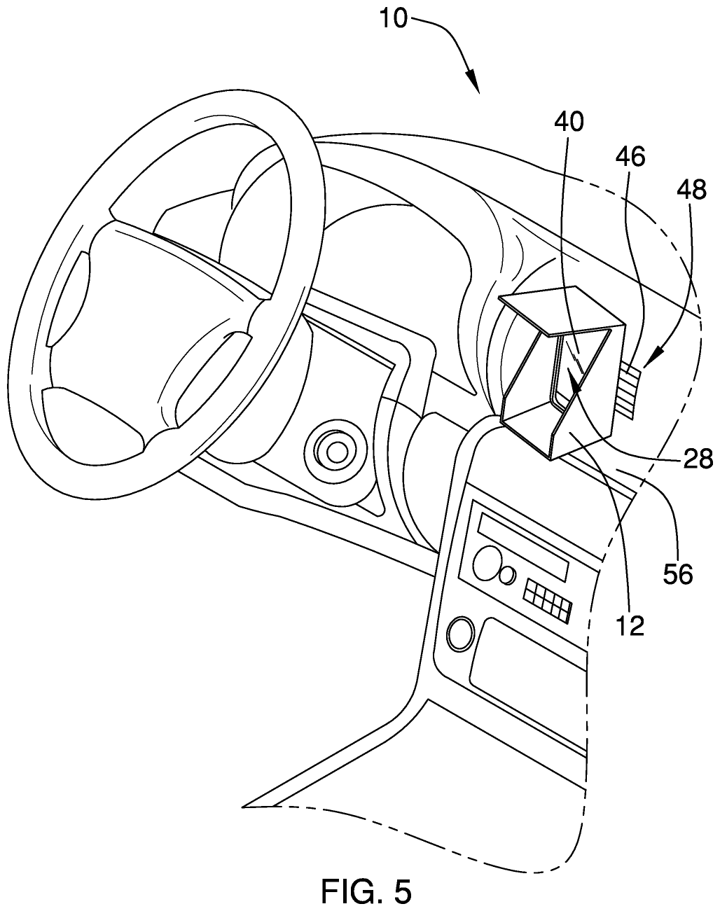

With reference now to the drawings, and in particular to FIGS. 1 through 5 thereof, a new personal electronic device carriers and shade device embodying the principles and concepts of an embodiment of the disclosure and generally designated by the reference numeral 10 will be described.

As best illustrated in FIGS. 1 through 5, the electronic device carrier and shade 10 generally comprises a housing 12. The housing 12 has a rear wall 14, a bottom wall 16, a top wall 18, a first lateral wall 20 and a second lateral wall 22. The housing 12 has a front side 24 which is open and forms an access into an interior 26 of the housing 12. The interior 26 is configured to removably receive a personal electronic device 28. The top wall 18 is attached to and extends forwardly from the rear wall 14. The bottom wall 16 has a distal edge 30 with respect to the rear wall 14. The distal edge 30 lies in a vertical plane 32 which is oriented perpendicular to a top side 34 of the bottom wall 16. The top wall 18 extends through the vertical plane 32 to shade the interior 26 of the housing 12. The housing 12 is made of any rigid material including wood, metal, rigid plastics, and conventionally available materials.

The top wall 18 is angled upwardly from the rear wall 14 such that an angle 36 formed between the rear wall 14 and the top wall 18 within the housing 12. The angle 36 is an obtuse angle. The obtuse angle 36 is less than 135°. The bottom wall 16 is oriented perpendicular to the rear wall 14. Each of the first lateral wall 20 and the second lateral wall 22 has a forward edge 38. The forward edge 38 is angled forwardly from the top wall 18 toward the bottom wall 16 wherein a depth of the first lateral wall 20 and the second lateral wall 22 is greater adjacent to the bottom wall 16 than adjacent to the top wall 18. The top wall 18 provides shade to the personal electronic device 28 and improves visibility of a display screen 40 of the personal electronic device 28.

A coupler 42 is attached to a back side 44 of the rear wall 14. The coupler 42 is configured to removably couple the housing 12 to louvers 46 of a car vent 48. The coupler 42 is pivotable with respect to the rear wall 14 to facilitate altering an orientation of the front side 24 relative to the car vent 48. The coupler 42 may removably couple the housing 12 to the louvers 46 of the car vent 48 using any mechanical means including friction grips, mechanical means to actively grab the louver, and other conventionally available mechanical coupling means.

A rear pad 50 is attached to the back side 44 of the rear wall 14. The rear pad 50 comprises a magnet. The rear pad 50 is positioned below the coupler 42. A bottom pad 52 is attached to a bottom side 54 of the bottom wall 16. The bottom pad 52 comprises a magnet. The rear pad 50 and the bottom pad 52 are configured to removably couple to a magnetic mount attached to a car interior 56. The bottom wall 16 has an aperture 58 extending therethrough. The aperture 58 is configured to allow a power cord to extend through the bottom wall 16. The aperture 58 is positioned nearer to the rear wall 14 than the distal edge 30 of the bottom wall 16. The bottom pad 52 is positioned between the aperture 58 and the distal edge 30.

In use, the housing 12 is coupled to the car interior 56 via the coupler 42, rear pad 50 or bottom pad 52. The personal electronic device 28 is placed within the interior 26 of the housing 12. The housing 12 is adjusted to best shade the display screen 40 of the personal electronic device 28 and improve visibility of the display screen 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A personal electronic device carrier and shade combination assembly being configured to facilitate viewing of a display screen, said assembly comprising:
a housing having a rear wall, a bottom wall, a top wall, a first lateral wall and a second lateral wall, said housing having a front side being open and forming an access into an interior of said housing, said interior being configured to removably receive a personal electronic device, said top wall being attached to and extending forwardly from said rear wall, said bottom wall having a distal edge with respect to said rear wall, said distal edge lying in a vertical plane being oriented perpendicular to a top side of said bottom wall, said top wall extending through said vertical plane to shade said interior of said housing; and
a coupler being attached to a back side of said rear wall, said coupler being configured to removably couple said housing to louvers of a car vent.

2. The personal electronic device carrier and shade combination assembly according to claim 1, wherein said top wall is angled upwardly from said rear wall such that an angle formed between said rear wall and said top wall within said housing being an obtuse angle.

3. The personal electronic device carrier and shade combination assembly according to claim 2, wherein said obtuse angle is less than 135°.

4. The personal electronic device carrier and shade combination assembly according to claim 1, wherein said bottom wall is oriented perpendicular to said rear wall

5. The personal electronic device carrier and shade combination assembly according to claim 1, wherein said first lateral wall and said second lateral wall each having a forward edge being angled forwardly from said top wall toward said bottom wall, wherein a depth of said first and second lateral walls is greater adjacent to said bottom wall than adjacent to said top wall.

6. The personal electronic device carrier and shade combination assembly according to claim 1, wherein said coupler is pivotable with respect to said rear wall to facilitate altering an orientation of said front side relative to the car vent.

7. The personal electronic device carrier and shade combination assembly according to claim 1, wherein a rear pad is attached to said back side of said rear wall, said rear pad comprising a magnet.

8. The personal electronic device carrier and shade combination assembly according to claim 7, wherein said rear pad is positioned below said coupler.

9. The personal electronic device carrier and shade combination assembly according to claim 1, wherein a bottom pad is attached to a bottom side of said bottom wall, said bottom pad comprising a magnet.

10. The personal electronic device carrier and shade combination assembly according to claim 1, wherein said bottom wall has an aperture extending therethrough.

11. The personal electronic device carrier and shade combination assembly according to claim 9, wherein said bottom wall has an aperture extending therethrough.

12. The personal electronic device carrier and shade combination assembly according to claim 11, wherein said aperture is positioned nearer to said rear wall than said distal edge of said bottom wall.

13. The personal electronic device carrier and shade combination assembly according to claim 10, wherein said aperture is positioned nearer to said rear wall than said distal edge of said bottom wall.

14. The personal electronic device carrier and shade combination assembly according to claim 12, wherein said bottom pad is positioned between said aperture and said distal edge.

15. A personal electronic device carrier and shade combination assembly being configured to facilitate viewing of a display screen, said assembly comprising:
a housing having a rear wall, a bottom wall, a top wall, a first lateral wall and a second lateral wall, said housing having a front side being open and forming an access into an interior of said housing, said interior being configured to removably receive a personal electronic device, said top wall being attached to and extending forwardly from said rear wall, said bottom wall having a distal edge with respect to said rear wall, said distal edge lying in a vertical plane being oriented perpendicular to a top side of said bottom wall, said top wall extending through said vertical plane to shade said interior of said housing;
said top wall being angled upwardly from said rear wall such that an angle formed between said rear wall and said top wall within said housing being an obtuse angle, said obtuse angle being less than 135°, said bottom wall being oriented perpendicular to said rear wall;
said first lateral wall and said second lateral wall each having a forward edge being angled forwardly from said top wall toward said bottom wall, wherein a depth of said first and second lateral walls is greater adjacent to said bottom wall than adjacent to said top wall;
a coupler being attached to a back side of said rear wall, said coupler being configured to removably couple said housing to louvers of a car vent, said coupler being pivotable with respect to said rear wall to facilitate altering an orientation of said front side relative to the car vent;
a rear pad being attached to said back side of said rear wall, said rear pad comprising a magnet, said rear pad being positioned below said coupler;
a bottom pad being attached to a bottom side of said bottom wall, said bottom pad comprising a magnet; and
said bottom wall having an aperture extending therethrough, said aperture being configured to allow a power cord to extend through said bottom wall, said aperture being positioned nearer to said rear wall than said distal edge of said bottom wall, said bottom pad being positioned between said aperture and said distal edge.
